(19) United States
(12) Patent Application Publication
(10) Pub. No.: US 2013/0279766 A1
(43) Pub. Date: Oct. 24, 2013

(54) Method for sharing the location of facial recognition systems using a wireless computing device

(71) Applicant: Judd McManus, Fairfax, VA (US)

(72) Inventor: Judd McManus, Fairfax, VA (US)

(21) Appl. No.: 13/452,902

(22) Filed: Apr. 22, 2012

(51) Int. Cl. G06K 9/00

(52) U.S. Cl. 382/118

(57) ABSTRACT

A method for sharing the location of facial recognition systems using a wireless computing device is presented.

Image capturing devices connected to facial recognition systems are becoming more and more pervasive in everyday life. Facial recognition systems able to identify a person as they move about in everyday life could one day be tied to computer systems connected to the Internet, tracking and storing the movement of an individual, employing a wide range of intrusive sales and marketing techniques, and data collection schemes everywhere an individual goes.

Through the invented method, sharing the location of facial recognition systems using a wireless computing device so that others may know and be able to avoid facial recognition systems can now be achieved.

### CROSS-REFERENCE TO RELATED APPLICATIONS

Not Applicable

### STATEMENT REGARDING FEDERALLY SPONSORED RESEARCH

Not Applicable

### REFERENCE TO A MICROFICHE APPENDIX

Not Applicable

### BACKGROUND OF THE INVENTION

A method for sharing the location of facial recognition systems using a wireless computing device is presented.

Image capturing devices connected to facial recognition systems are becoming more and more pervasive in everyday life. Facial recognition systems able to identify a person as they move about in everyday life could one day be tied to computer systems connected to the Internet, tracking and storing the movement of an individual, employing a wide range of intrusive sales and marketing techniques, and data collection schemes everywhere an individual goes. The benefits of being able to know and avoid a certain facial recognition system that may facilitate the employment of intrusive sales and marketing techniques, and data collection schemes as an individual moves about in everyday life are immense.

Accordingly, it is an object of this invention to provide a new method for sharing the location of facial recognition systems using a wireless computing device. Furthermore, it is an object of this invention to provide for the key series of steps needed to share the location of facial recognition systems using a wireless computing device.

Through the invented method, sharing the location of facial recognition systems using a wireless computing device so that others may know and be able to avoid facial recognition systems can now be achieved.

### BRIEF SUMMARY OF THE INVENTION

The invented method for sharing the location of facial recognition systems using a wireless computing device is configured to include a transmitting wireless computing device, a facial recognition system, transmitted GPS location, server software, receiving wireless computing device, using said transmitting wireless computing device to mark the GPS location of said facial recognition system, using said transmitting wireless computing device to transmit said GPS location to said server software, said server software transmitting said GPS location to said receiving wireless computing device, whereby said GPS location of said facial recognition system can now be shared with others.

### BRIEF DESCRIPTION OF DRAWING

FIG. 1—Sample configuration to perform the invented method

### DETAILED DESCRIPTION OF THE INVENTION

The invented method for sharing the location of facial recognition systems using a wireless computing device is configured to include a transmitting wireless computing device, a facial recognition system, transmitted GPS location, server software, receiving wireless computing device, using said transmitting wireless computing device to mark the GPS location of said facial recognition system, using said transmitting wireless computing device to transmit said GPS location to said server software, said server software transmitting said GPS location to said receiving wireless computing device, whereby said GPS location of said facial recognition system can now be shared with others.

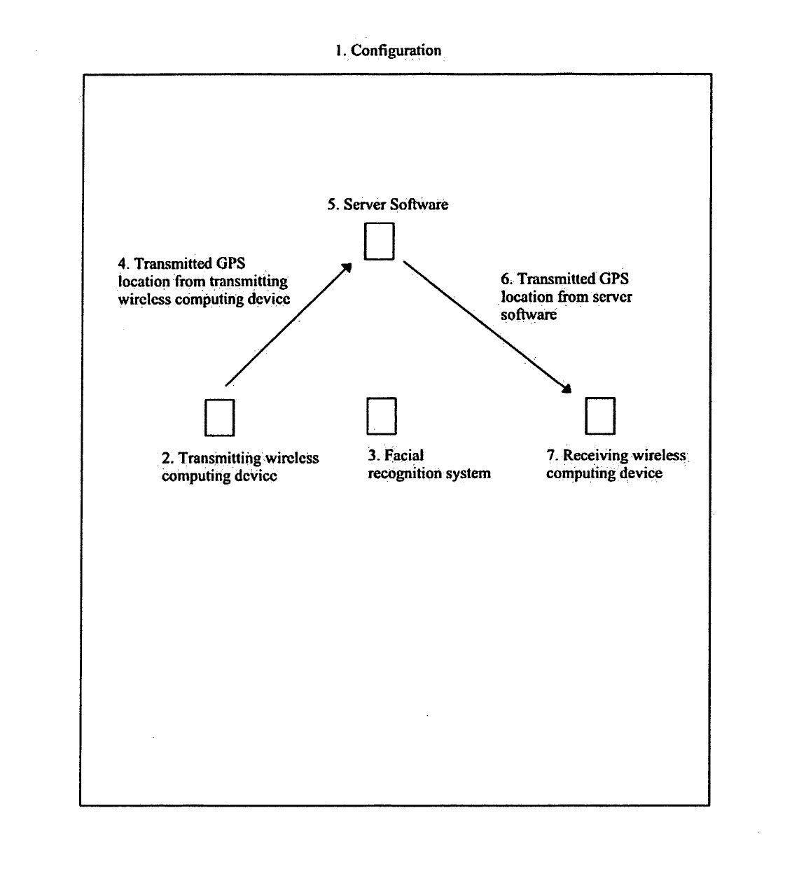

FIG. 1 shows a sample configuration (1) containing a transmitting wireless computing device (2), a facial recognition system (3), transmitted GPS location from transmitting wireless computing device (4), server software (5), transmitted GPS location from server software (6), receiving wireless computing device (7).

To replicate the invented method we set up the configuration (1) as shown in FIG. 1. As an individual with a transmitting wireless computing device (2) with GPS technology comes into contact with a facial recognition system (3), the GPS location is marked using a client side software application on the transmitting wireless computing device.

The transmitting wireless computing device then transmits the GPS location (4) to server software (5), which then transmits the GPS location (6) to a receiving wireless computing device (7) with a client side software application that alerts the user of the nearby facial recognition system, thus enabling the sharing of the GPS location of the facial recognition system with others.

Although the above description contains specifics, these should not be construed as limiting the scope of the invention, but as providing illustrations of some of the presently preferred embodiments of this invention.

Thus the scope of the invention should be determined by the appended claims and their legal equivalents, rather than by the example given.

I claim:

1. Method for sharing the location of a facial recognition system, comprising a wireless computing device, a facial recognition system, transmitted location, server software, using said wireless computing device to mark the location of said facial recognition system, using said wireless computing device to transmit said location to said server software, whereby said location of said facial recognition system can now be shared with others.

2. Method for sharing the location of a facial recognition system, comprising the steps of claim 1 where transmitted location contains GPS coordinates.

3. Method for sharing the location of a facial recognition system, comprising the steps of claim 1 where said wireless computing device has a client-side software application for marking said location.

4. Method for sharing the location of a facial recognition system, comprising the steps of claim 1 where said server software transmits said location to receiving wireless computing device.

5. Method for sharing the location of a facial recognition system, comprising the steps of claim 1 where wireless computing device has a client-side software application which alerts user said facial recognition system is nearby.
